(19) United States
(12) Patent Application Publication
(10) Pub. No.: US 2025/0324318 A1
(43) Pub. Date: Oct. 16, 2025

(54) MODEM RECOMMENDATIONS FOR TRAFFIC SPLITTING

(71) Applicant: QUALCOMM Incorporated, San Diego, CA (US)

(72) Inventors: Diana MAAMARI, San Diego, CA (US); Mickael MONDET, Louannec (FR); Peerapol TINNAKORNSRISUPHAP, San Diego, CA (US); Prashanth Haridas HANDE, San Diego, CA (US); Sunghoon KIM, San Diego, CA (US); Dario Serafino TONESI, San Diego, CA (US); Hong CHENG, Basking Ridge, NJ (US); Aziz GHOLMIEH, Del Mar, CA (US)

(21) Appl. No.: 18/634,081

(22) Filed: Apr. 12, 2024

(51) Int. Cl. H04W 28/02; H04L 45/24; H04W 28/08

(52) U.S. Cl. CPC H04W 28/0263; H04W 28/0236; H04W 28/0247; H04W 28/0967; H04L 45/24

(57) ABSTRACT

Various aspects of the present disclosure generally relate to wireless communication. In some aspects, a first user equipment (UE) may identify, by a modem of the first UE, a recommended traffic split between a first connection associated with the first UE and a second connection associated with a second UE. The first UE may provide, by the modem, assistance information indicating the recommended traffic split using a cross-layer application programming interface (API). Numerous other aspects are described.

### FIELD OF THE DISCLOSURE

Aspects of the present disclosure generally relate to wireless communication and specifically relate to techniques, apparatuses, and methods for modem recommendations for traffic splitting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some implementations, an apparatus for wireless communication at a first user equipment (UE) includes one or more memories; and one or more processors coupled to the one or more memories, the one or more processors individually or collectively configured to: identify, by a modem of the first UE, a recommended traffic split between a first connection associated with the first UE and a second connection associated with a second UE; and provide, by the modem, assistance information indicating the recommended traffic split using a cross-layer application programming interface (API).

In some implementations, a method of wireless communication performed by a first UE includes identifying, by a modem of the first UE, a recommended traffic split between a first connection associated with the first UE and a second connection associated with a second UE; and providing, by the modem, assistance information indicating the recommended traffic split using a cross-layer API.

In some implementations, a non-transitory computer-readable medium storing a set of instructions for wireless communication includes one or more instructions that, when executed by one or more processors of a first UE, cause the first UE to: identify, by a modem of the first UE, a recommended traffic split between a first connection associated with the first UE and a second connection associated with a second UE; and provide, by the modem, assistance information indicating the recommended traffic split using a cross-layer API.

In some implementations, a first apparatus for wireless communication includes means for identifying, by a modem of the first apparatus, a recommended traffic split between a first connection associated with the first apparatus and a second connection associated with a second apparatus; and means for providing, by the modem, assistance information indicating the recommended traffic split using a cross-layer API.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a companion UE and an anchor UE, in accordance with the present disclosure.

FIG. 5 is a diagram illustrating an example of a multipath relay system, in accordance with the present disclosure.

FIG. 6 is a diagram illustrating an example of a multipath relay system, in accordance with the present disclosure.

FIG. 7 is a diagram illustrating an example of synchronization requirements for multi-modality, in accordance with the present disclosure.

FIGS. 8-10 are diagrams illustrating examples associated with modem recommendations for traffic splitting, in accordance with the present disclosure.

FIG. 11 is a diagram illustrating an example process associated with modem recommendations for traffic splitting, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Extended reality (XR) devices, such as XR glasses or other wearables (e.g., smart watches) may be associated with relatively small form factors, as compared to full capability user equipments (UEs) (e.g., smart phones). Such small form factors may result in a limited number of antennas for certain bands, as compared to full capability UEs. For example, the small form factor may prevent XR devices from having 4 receive (Rx) antennas in certain 5G bands, which may be common in full capability UEs. Rather, XR glasses may be limited to two Rx antennas and smart watches may be limited to a single Rx antenna. XR devices, having fewer Rx antennas as compared to full capability UEs, may have a disadvantage in terms of performance in relation to full capability UEs.

To alleviate some of the performance disadvantages described above, in some scenarios, an XR device, which may be considered to be an anchor UE, may cooperate with a relay UE (or companion UE), which may serve to improve a performance of the anchor UE. For example, the anchor UE and the relay UE may be aggregated into a virtual UE to maximize multiple-input multiple-output (MIMO) gains or to allow for path switching/splitting. In this companion scenario, the relay UE may provide data forwarding to the anchor UE and the anchor UE and the relay UE may communicate with each other over one or more types of links, such as a ultrawideband (UWB) link, a PC5 NR sidelink link (licensed or unlicensed), a WiFi link, a Bluetooth link, a universal serial bus (USB) link, a frequency range 2 (FR2) link, and/or the like. As an example, the anchor UE may have one or two Rx antennas, and by using cooperation with the relay UE, a virtual UE with four or more Rx antennas may be formed. Thus, an XR device may operate as though it has more Rx antennas than physically configured for the XR device.

In some scenarios, the companion UE may be a layer 3 (L3) multipath relay UE. In order to support L3 multipath relay, there can be various options for a traffic switching or splitting, for uplink traffic. For example, in a first option, an access traffic steering switching splitting (ATSSS) functionality in an application client of the anchor UE may split traffic into a first data flow and a second data flow where the first data flow may be to or from the anchor UE and the second data flow may be to or from the relay UE. In the first option, the ATSSS functionality may split or aggregate the traffic at a user plane function (UPF) below an Internet Protocol (IP) layer of the application client. In the second option, a multipath quick user datagram protocol (UDP) Internet connection (MPQUIC) layer (or multipath transport/control protocol (MPTCP) layer) in the application client of the anchor UE may split traffic into the first data flow and the second data flow, or the MPQUIC layer (or the MPTCP layer) may aggregate the first data flow and the second data flow.

When the first option is used, the anchor UE may provide UE assistance information to the UPF, which may allow a default uplink or downlink distribution to be changed (e.g., the anchor UE may use ATSSS and local conditions to determine a split for uplink traffic and the UPF may use N4 rules and feedback from the anchor UE for splitting downlink traffic). However, when the second option is used, such UE assistance information may not be supported by the anchor UE. In other words, when the MPQUIC layer is responsible for splitting traffic above the IP layer of the application client, the anchor UE may not be configured to support UE assistance information. As a result, when the MPQUIC layer is responsible for splitting traffic above the IP layer of the application client, the anchor UE may be unable to change a default uplink distribution. For example, the anchor UE may be unable to change a distribution between a first data flow and a second data flow, which may negatively impact an overall performance of the anchor UE.

Various aspects relate generally to modem recommendations for traffic splitting. For example, a modem of an anchor UE may provide assistance information to an MPQUIC aware application of the anchor UE, an application client of the anchor UE, and/or an application server, when a transport layer splitting or aggregation is above an IP layer in the anchor UE or the application server, respectively. The modem may provide the assistance information using a cross-layer application programming interface (API) cross-layer and the assistance information may recommend a split or load balancing of uplink or downlink traffic among two connections, where a first connection may be associated with the anchor node and a second connection may be associated with a relay node. The modem may provide a recommendation or assistance information for an uplink traffic split through the cross-layer API to the MPQUIC aware application. Alternatively, the modem may provide a recommendation or assistance information for a downlink traffic split through the cross-layer API to the application client, and the application client may forward the recommendation or assistance information to an application server. The application server may determine whether or not to implement the recommended downlink traffic split.

Some aspects more specifically relate to modem recommendations for uplink or downlink traffic splitting. In some examples, a modem of a first UE (e.g., an anchor UE) may identify a recommended traffic split between a first connection associated with the first UE and a second connection associated with a second UE (e.g., a relay UE). The recommended traffic split may be for a downlink adaptive load balancing via an application server. Alternatively, the recommended traffic split may be for an uplink adaptive load balancing via the first UE. The modem of the first UE may provide assistance information using a cross-layer API, where the assistance information may indicate the recommended traffic split. The cross-layer API may be a dedicated API to an MPQUIC aware application of the first UE, or the cross-layer API may be to an application client of the first UE. The assistance information may include information on a first link condition associated with the first connection and a second link condition associated with the second connection. In some aspects, the application client of the UE may forward the assistance information to the application server.

Particular aspects of the subject matter described in this disclosure can be implemented to realize one or more of the following potential advantages. In some examples, by enabling assistance information that indicates a recommended traffic split, the described techniques can be used by the first UE to split uplink traffic or by an application server to split downlink traffic in accordance with the assistance information. The assistance information, which may be enabled by the cross-layer API, may be applicable when a packet aggregation or splitting is performed above an IP layer of the first UE or the application server, respectively, as opposed to being performed below an IP layer at the first UE or at a UPF. The cross-layer API may allow the modem of the first UE to relay the assistance information to the MPQUIC aware application or to the application server. As a result of the assistance information, the modem of the first UE is able to control load balancing and/or traffic splitting based on first UE link conditions as well as second UE link conditions, thereby improving an overall system performance.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

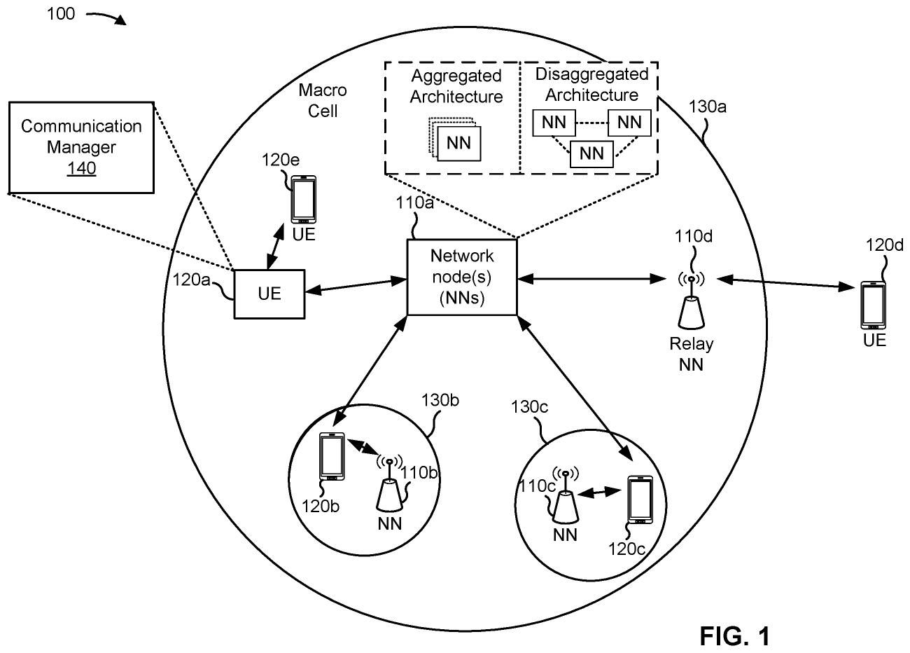

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a first UE (e.g., UE 120a) may include a communication manager 140. As described in more detail elsewhere herein, the communication manager 140 may identify, by a modem of the first UE, a recommended traffic split between a first connection associated with the first UE and a second connection associated with a second UE (e.g., UE 120e); and provide, by the modem, assistance information indicating the recommended traffic split using a cross-layer API. Additionally, or alternatively, the communication manager 140 may perform one or more other operations described herein.

As indicated above, FIG. 1 is provided as an example. Other examples may differ from what is described with regard to FIG. 1.

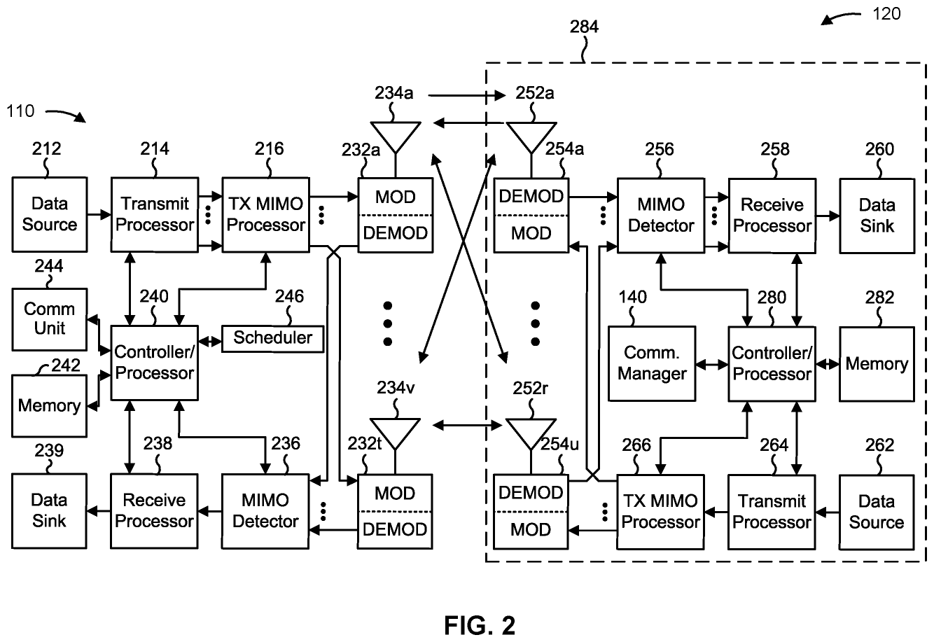

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

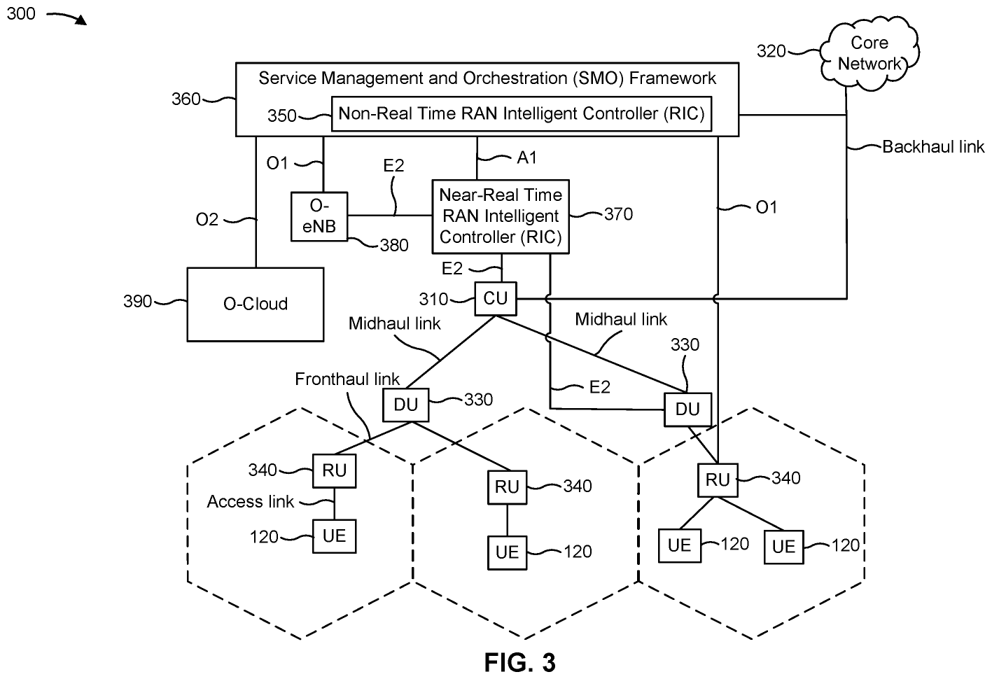

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

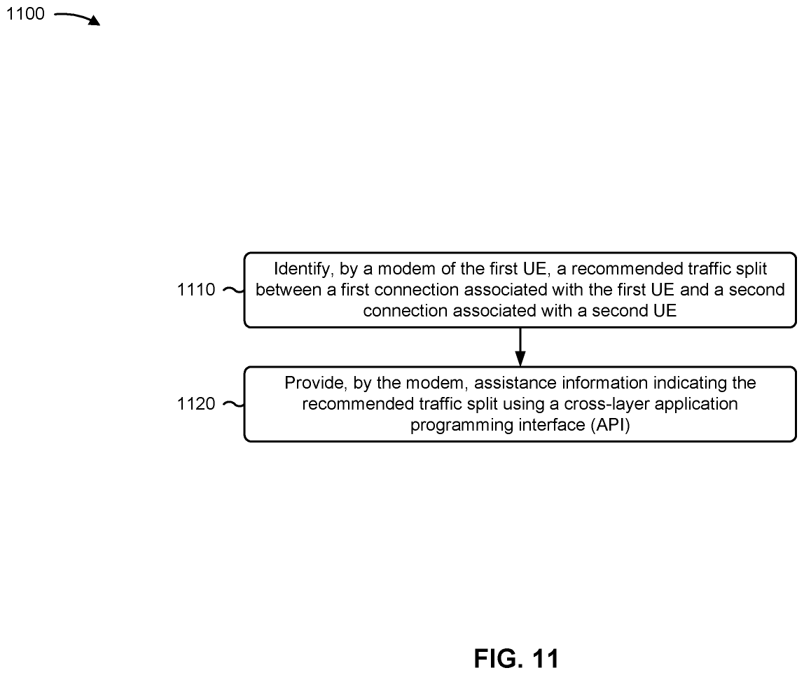

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with modem recommendations for traffic splitting, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, or other processes as described herein. In some examples, executing instructions may include running the instructions, converting the instructions, compiling the instructions, and/or interpreting the instructions, among other examples.

In some aspects, a first UE (e.g., UE 120a) includes means for identifying, by a modem of the first UE, a recommended traffic split between a first connection associated with the first UE and a second connection associated with a second UE (e.g., UE 120e); and/or means for providing, by the modem, assistance information indicating the recommended traffic split using a cross-layer API. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

XR devices, such as XR glasses or other wearables (e.g., smart watches) may be associated with relatively small form factors, as compared to full capability UEs (e.g., smart phones). Such small form factors may result in a limited number of antennas for certain bands, as compared to full capability UEs. For example, XR devices may not allow for 4 receive (Rx) antennas in certain 5G bands, which may be common in full capability UEs. Rather, XR devices may be limited to two Rx antennas and smart watches may be limited to a single Rx antenna. In other words, a subset of XR devices may have two or less Rx antennas when operating in a bandwidth of 100 MHz. On the other hand, full capability UEs may be required to have at least four Rx antennas. XR devices, having fewer Rx antennas as compared to full capability UEs, may have a disadvantage in terms of performance in relation to full capability UEs.

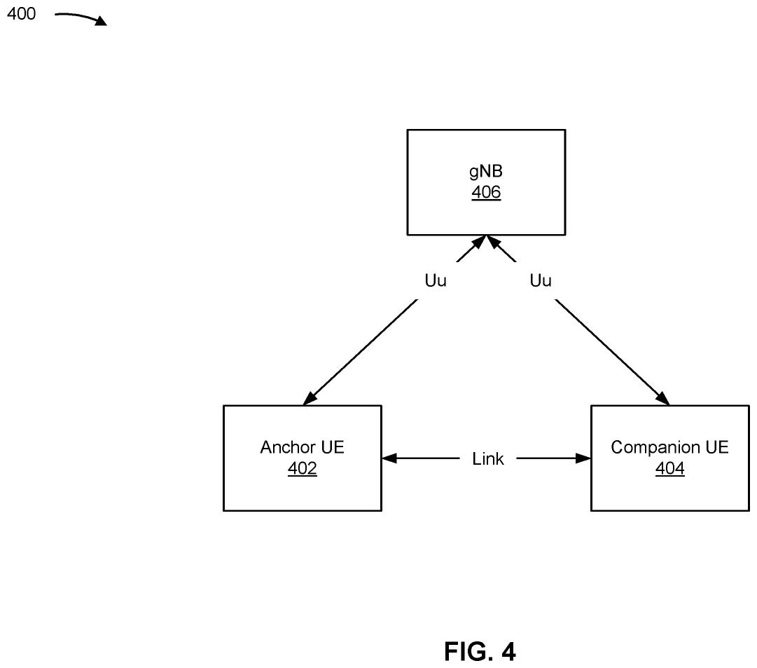

FIG. 4 is a diagram illustrating an example 400 of a companion UE and an anchor UE, in accordance with the present disclosure.

As shown in FIG. 4, an anchor UE 402 may communicate with a gNB 406 via a first Uu link. For example, the anchor UE 402 may be XR glasses or a smart watch. The anchor UE 402 may use a cellular antenna to communicate with the gNB 406. A companion UE 404 may communicate with the gNB 406 via a second Uu link. For example, the companion UE 404 may be a smartphone. The companion UE 404 may use a cellular antenna to communicate with the gNB 406. The companion UE 404 may be a layer 2 (L2) or layer 3 (L3) multipath relay UE (or relay UE). The companion UE 404 may provide data forwarding to the anchor UE 402 at L3 or above. The anchor UE 402 and the companion UE 404 may communicate with each other over a link. The link may support an ultra-wideband (UWB) based data communication, a PC5 NR sidelink communication (e.g., licensed or unlicensed communication), a WiFi communication, a Bluetooth communication, or an FR2 based communication. The link may be a low power, high bandwidth, low latency, and high reliability cooperative link. For example, the anchor UE 402 and the companion UE 404 may each use a sidelink modem that allows communication between the anchor UE 402 and the companion UE 404. The anchor UE 402 and the companion UE 404 may be aggregated into a virtual UE to maximize MIMO gains and to allow for patch switching or splitting. As an example, the anchor UE 402 (e.g., augmented reality (AR) glasses or wearable) may have one or two Rx antennas, and by using cooperation with the companion UE 404, a virtual UE with four or more Rx antennas may be formed.

As indicated above, FIG. 4 is provided as an example. Other examples may differ from what is described with regard to FIG. 4.

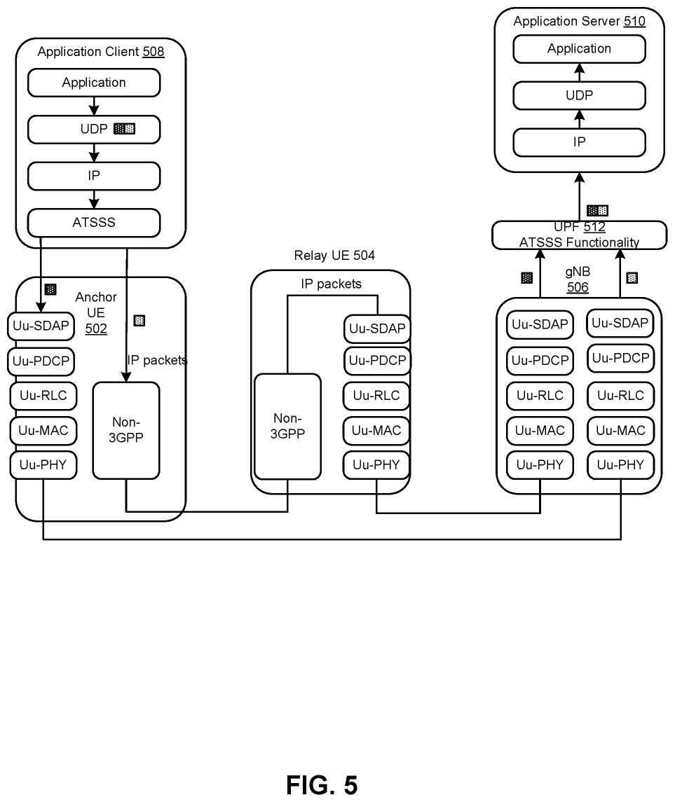

FIG. 5 is a diagram illustrating an example 500 of a multipath relay system, in accordance with the present disclosure. The example 500 includes an anchor UE 502, a relay UE 504, a gNB 506, an application client 508, an application server 510, and a UPF 512. The application client 508 may run on the anchor UE 502.

As shown in FIG. 5, a UDP layer of the application client 508 may identify a packet. For example, the packet may be associated with XR traffic. The UDP layer may split the packet. A first portion of the packet may be provided to an SDAP layer of the anchor UE 502. A second portion of the packet may be provided to a non-3GPP layer of the anchor UE 502. The first portion of the packet may be transmitted from the anchor UE 502 to the gNB 506 via the relay UE 504. A first SDAP layer of the gNB 506 may provide the first portion of the packet to the UPF 512. The UPF 512 may be associated with an ATSSS functionality. The second portion of the packet may be transmitted from the anchor UE 502 to the gNB 506 via the relay UE 504. A second SDAP layer of the gNB 506 may provide the second portion of the packet to the UPF 512. The UPF 512 may aggregate the first portion of the packet and the second portion of the packet, to form an aggregated packet, and the aggregated packet may be provided to the application server 510.

As shown in FIG. 5, the relay UE 504 may be supported using ATSSS at both the application client 508 and the UPF 512, which may allow packets to be split/combined among two paths. A splitting and aggregation at the anchor UE 502 and the UPF 512, respectively, may occur below an IP layer. In other words, with ATSSS, the UPF 512 and the anchor UE 502, below the IP layer, may perform traffic steering, switching, and/or splitting. Traffic of a data flow may be split across multiple access networks. Some traffic of the data flow may be transferred via one access network and other traffic of the same data flow may be transferred via another access network. The anchor UE 502 may use ATSSS rules and location conditions to determine a manner in which to split uplink traffic. Similarly, the UPF 512 may use rules and/or feedback from the UE for splitting downlink traffic. In an uplink, IP packet aggregation may be at the UPF 512

With an ATSSS solution, the anchor UE 502 may provide UE assistance information to the UPF 512. The anchor UE 502 may provide, to the UPF 512 and via the UE assistance information, a downlink traffic distribution which may be applied by the UPF 512 for downlink traffic. The UE assistance information may inform the UPF 512 on a manner in which to change a default uplink distribution. In other words, the UE assistance information may be applicable to downlink traffic or uplink traffic.

As indicated above, FIG. 5 is provided as an example. Other examples may differ from what is described with regard to FIG. 5.

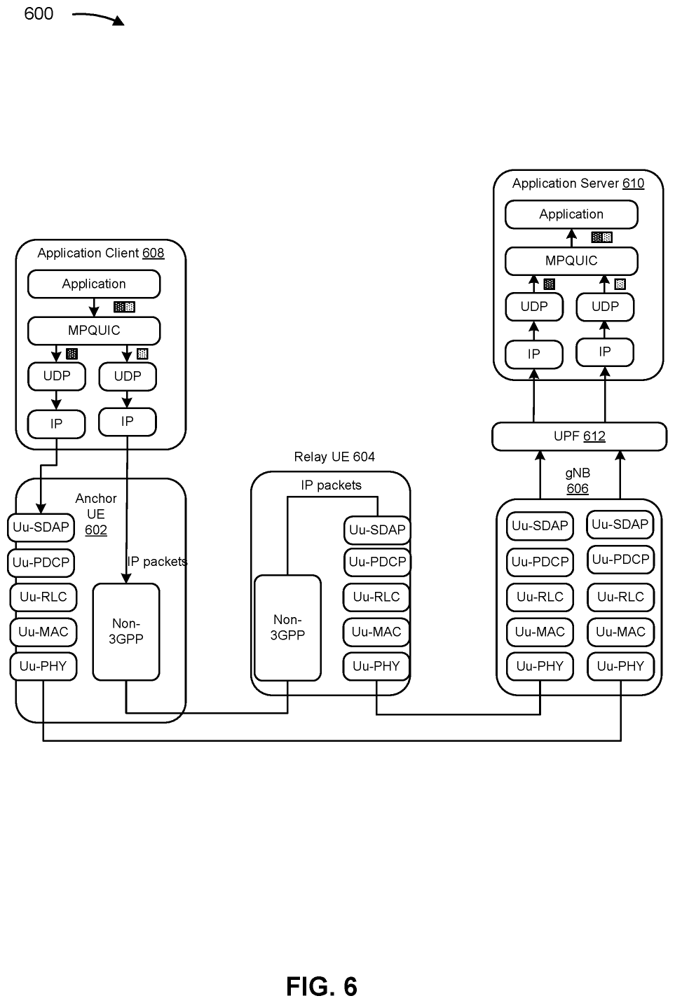

FIG. 6 is a diagram illustrating an example 600 of a multipath relay system, in accordance with the present disclosure. The example 600 includes an anchor UE 602, a relay UE 604, a gNB 606, an application client 608, an application server 610, and a UPF 612. The application client 608 may run on the anchor UE 602.

As shown in FIG. 6, an application of the application client 608 may identify a packet. For example, the packet may be associated with XR traffic. The application may provide the packet to an MPQUIC, which may split the packet. A first portion of the packet may be provided to a first UDP layer of the application client 608 and a second portion of the packet may be provided to a second UDP layer of the application client 608. The first portion of the packet may be transmitted from the anchor UE 602 to the gNB 606 via the relay UE 604. The second portion of the packet may be transmitted from the anchor UE 602 to the gNB 606 via the relay UE 604. The first portion of the packet may be received at a UDP layer of the application server 610. The second portion of the packet may be received at a UDP layer of the application server 610. An MPQUIC at the application server 610 may aggregate the first portion of the packet and the second portion of the packet, to form an aggregated packet, and the aggregated packet may be provided to an application running on the application server 610.

As shown in FIG. 6, the relay UE 604 may be supported using over-the-top-above-IP aggregation. An aggregation and splitting at the application server 610 and the application client 608, respectively, may be above an IP layer, which may be achieved using an over-the-top MPQUIC or multipath transmission control protocol (MPTCP) proxy. Separate packet data unit (PDU) sessions may be formed for the anchor UE 602 and the relay UE 604. In an uplink, an aggregation of packets from different links may occur at the application server 610, and a splitting of packets may occur at the application client 608.

As indicated above, FIG. 6 is provided as an example. Other examples may differ from what is described with regard to FIG. 6.

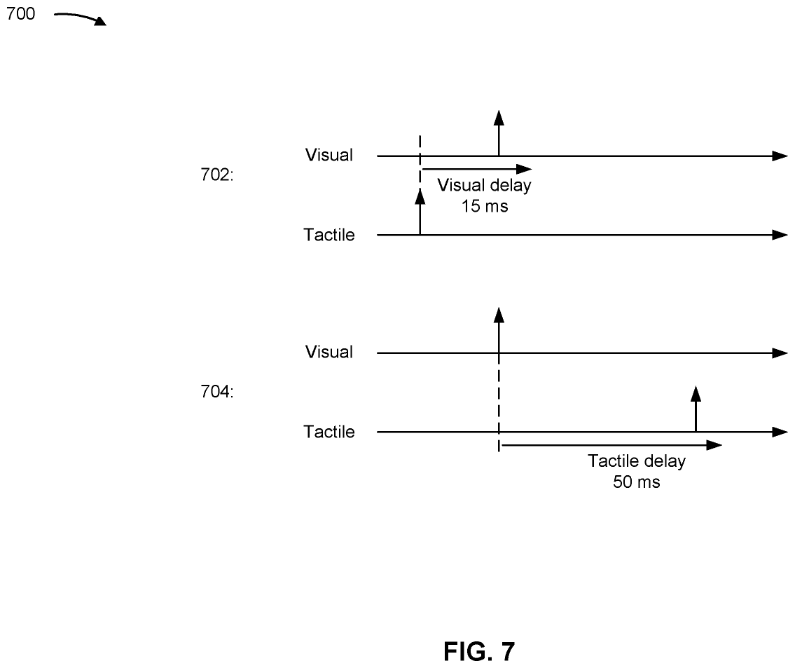

FIG. 7 is a diagram illustrating an example 700 of synchronization requirements for multi-modality, in accordance with the present disclosure.

Synchronization requirements may be specified for a multi-modal scenario. Audio, visual, and tactile flows may have different periodicities. Synchronization requirements may be specified between two flows (e.g., audio and tactile, or video and tactile). For an audio-tactile scenario, a synchronization threshold for an audio delay may be approximately 50 ms, and a synchronization threshold for a tactile delay may be approximately 25 ms. For a visual-tactile scenario, as shown by reference number 702, a synchronization threshold for a visual delay may be approximately 15 ms, and as shown by reference number 704, a synchronization threshold for a tactile delay may be approximately 50 ms. For each media component, “delay” may refer to the case in which that media component is delayed as compared to another media component.

As indicated above, FIG. 7 is provided as an example. Other examples may differ from what is described with regard to FIG. 7.

In various aspects of techniques and apparatuses described herein, a modem of an anchor UE may provide assistance information to an MPQUIC aware application of the anchor UE, an application client of the anchor UE, and/or an application server, when a transport layer splitting or aggregation is above an IP layer in the anchor UE or the application server, respectively. The modem may provide the assistance information using a cross-layer API to the MPQUIC aware application and/or a cross-layer API to the application client. The assistance information may recommend a split or load balancing among two connections, where a first connection may be associated with the anchor node and a second connection may be associated with a relay node. A recommendation of the split or load balancing may be for uplink traffic or downlink traffic. The modem may provide a suggestion or assistance on an uplink traffic split through the cross-layer API to the MPQUIC aware application. Alternatively, the modem may provide a suggestion or assistance on a downlink traffic split through the cross-layer API to the application client, and the application may forward the suggestion or assistance to an application server. The application may determine whether or not to implement the recommended downlink traffic split.

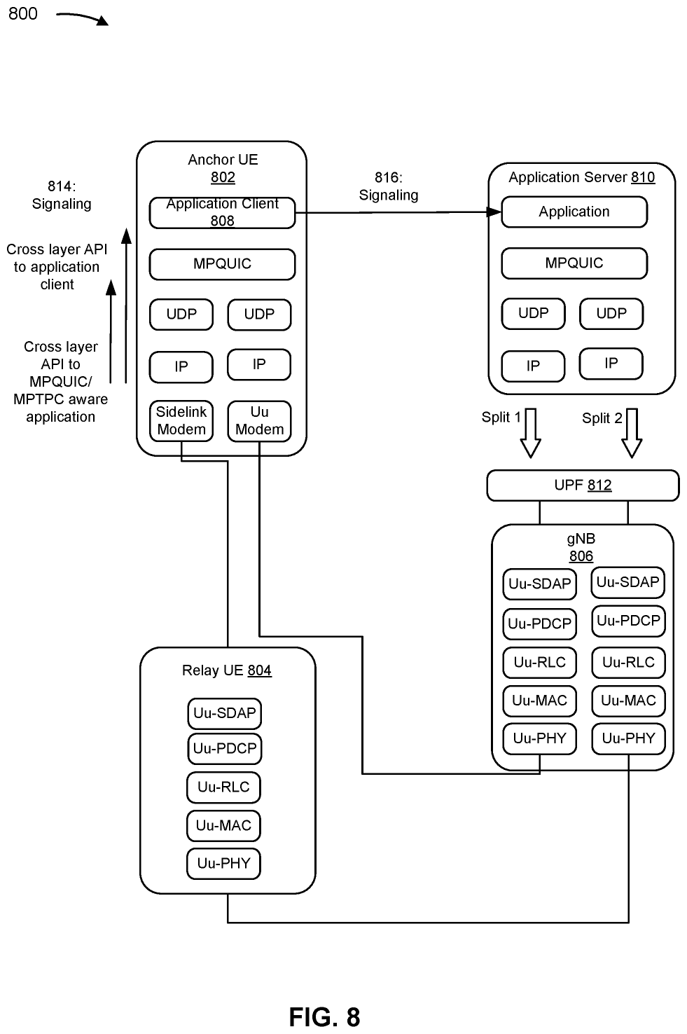

FIG. 8 is a diagram illustrating an example 800 associated with modem recommendations for traffic splitting, in accordance with the present disclosure. The example 800 includes an anchor UE 802, a relay UE 804, a gNB 806, an application client 808, an application server 810, and a UPF 812. The application client 808 may run on the anchor UE 802. The anchor UE 802 may include the application client 808, an MPQUIC or MPTCP aware application, a UDP layer, an IP layer, and one or more modems, such as a sidelink modem and a Uu modem. The application server 810 may include an application, an MPQUIC or MPTCP aware application, a UDP layer, and an IP layer. Although FIG. 8 illustrates an example of splitting packets above the IP layer of the application server 810 (e.g., at the MPQUIC layer), the architecture illustrated in FIG. 8 may be used for aggregation of packets above the IP layer.

FIG. 8 illustrates an example of downlink adaptive load balancing according to some aspects described herein. In downlink load balancing, the anchor UE 802 may recommend splitting packets of a same service data flow (SDF) or different SDFs over two connections above the IP layer using the MPQUIC or MPTCP aware application, as described in more detail below. In some aspects, as shown by reference number 814 the modem of the anchor UE 802 (e.g., a sidelink modem and/or a Uu modem) may use signaling to provide assistance information. For example, the modem may use a cross-layer API to an MPQUIC/MPTCP aware application layer and/or a cross-layer API to the application client 808 to provide the assistance information on link conditions for various connections to/from the anchor UE 802. As shown by reference number 816, the application client 808 may signal the assistance information, received from the modem of the anchor UE 802, to the application server 810. The application server 810 may perform the downlink adaptive load balancing based on the assistance information.

As a specific example, the link conditions may include a first link condition associated with the anchor UE 802, and a second link condition associated with the relay UE 804. The first link condition may be a condition of the anchor UE 802. The second link condition may be a condition of the relay UE 804. The connections to/from the anchor UE 802 may include a first connection and a second connection. The first connection may be between the anchor UE 802, the relay UE 804, the gNB 806, the UPF 812, and the application server 810. The second connection may be between the anchor UE 802, the gNB 806, the UPF 812, and the application server 810.

In some examples, the cross-layer API to the MPQUIC/MPTCP aware application and/or the cross-layer API to the application client 808 may be used to provide a recommendation or information on a sidelink. For example, the modem at the anchor UE 802 may provide a suggestion or assistance on an uplink traffic split through the cross-layer API to the MPQUIC/MPTCP aware application and/or the cross-layer API to the application client 808. The application client 808 or the MPQUIC/MPTCP aware application may, at 816, provide the recommended split of the downlink traffic accordingly to the application server 810.

In this way, in a downlink adaptive load balancing, the modem of the anchor UE 802 (or multiple modems of the anchor UE 802) may recommend a split or load balancing among the two connections by providing assistance information about the two link conditions. For example, the modem of the anchor UE 802 may provide a recommendation on a downlink split between the two connections. The modem of the anchor UE 802, via the cross-layer API for to MPQUIC/MPTCP aware application and/or the cross-layer API to the application client 808, may send such assistance information to the application client 808. The application client 808 may forward the assistance information to the application server 810 (e.g., via in-band signaling). In this case, the downlink adaptive load balancing may be achieved using signaling from the application client 808 to the application server 810.

The architecture illustrated in FIG. 8 may additionally or alternative by used for uplink adaptive load balancing. For example, in an uplink adaptive load balancing, a splitting or load balancing of packets of a same SDF or different SDFs may be based at least in part on a recommendation from the anchor UE 802. The modem of the anchor UE 802 (or multiple modems of the anchor UE 802) may provide a recommendation for the splitting or load balancing to the application client 808. The modem of the anchor UE 802 may provide the recommendation using the cross-layer API to the MPQUIC/MPTCP aware application (e.g., a dedicated API for MPQUIC/MPTCP aware applications). The modem of the anchor UE 802 may consider its own radio link conditions, radio link conditions of the relay UE 804, and/or UE-to-UE link conditions. The radio link conditions of the anchor UE 802 may correspond to a radio link, and may indicate an associated throughput (e.g., bandwidth) and amount of delay. The radio link conditions of the relay UE 804 may correspond to a companion link, and may indicate an associated throughput and amount of delay. The UE-to-UE link conditions may correspond to a link between the anchor UE 802 and the relay UE 804, and may indicate an associated throughput and amount of delay. In this example, the modem of the anchor UE 802 may provide a suggestion or assistance on an uplink traffic split through the cross-layer API to the MPQUIC/MPTCP aware application, and the MPQUIC/MPTCP aware application may split the uplink traffic accordingly.

As described herein, the application client 808 may be located at the anchor UE 802. By using the cross-layer API to the application client 808, the modem of the anchor UE 802 may provide the application client 808 with assistance information for load balancing over various connections (e.g., two connections). The assistance information provided by the modem of the anchor UE 802 may include information on a direct link condition, an indirect link condition, and/or a sidelink condition. The cross-layer API to the MPQUIC/MPTCP aware application may implement the assistance information as is or with some modification. The modem of the anchor UE 802 may provide to the application client 808, or directly to an operating system, an uplink traffic distribution which may be applied by an application client proxy MPQUIC (through an API) for uplink traffic that applies to the assistance information. In other words, by using a cross-layer API, the modem of the anchor UE 802 may provide a suggestion or assistance on an uplink traffic split, and then the application client 808 may split traffic between two connections through a dedicated MPQUIC/MPTCP aware application. The modem of the anchor UE 802 may determine a manner in which to distribute the uplink traffic of a matching SDF based at least in part on its own link conditions, as well as relay UE link conditions. The assistance information may be information associated with link conditions of the two connections and/or a UE-to-UE connection, delay status reports, bandwidth, and/or throughput.

In some aspects, and as described herein, the modem of the anchor UE 802 may provide signaling to the application client 808, and the application client 808 may provide signaling to the application server 810. For example, the modem of the anchor UE 802 may provide, to the application server 810, UE assistance that indicates a downlink traffic distribution. The downlink traffic distribution may be applied by an application server proxy MPQUIC/MPTCP for all downlink traffic that applies to the UE assistance.

In some aspects, the modem of the anchor UE 802 may be allowed to control load balancing and/or splitting when an aggregation and/or splitting is above an IP layer, rather than at the UPF 812 in a downlink and below an IP layer at the anchor UE 802 with ATSSS. The modem of the anchor UE 802 may be allowed to control load balancing and/or splitting based at least in part on anchor UE link conditions as well as relay UE link conditions and/or sidelink conditions. Signaling to the application client 808 and/or the application server 810 may be through cross-layer APIs. The MPQUIC/MPTCP aware application may then forward a suggestion to an operating system.

In some aspects, a multi-modal synchronization requirement may be maintained. Multi-modality may refer to two quality of service (QOS) flows for which synchronization requirements are to be maintained for an end user to experience no asynchrony. For example, for audio and tactile QoS flows, the synchronization requirement cannot exceed 15 ms between associated packets of the two separate flows. In an uplink, the anchor UE 802 implementing an application may be aware of an experienced delay and may suggest a split to the application client 808 based at least in part on the synchronization requirement and link conditions at both the anchor UE 802 and the relay UE 804.

In some aspects, signaling from the modem of the anchor UE 802 to the application client 808 may be through cross-layer API(s). The signaling from the modem of the anchor UE 802 to the application client 808, and then to the application server 810, may be based at least in part on two options. In a first option, the signaling may be in-band signaling. In a second option, the signaling may be control plane signaling from the anchor UE 802, to the gNB 806, to an AMF (not shown), to a session management function (SMF) (not shown), to a network exposure function (NEF) (not shown), and then to the application server 810. The control plane signaling may include assistance information. The assistance information may indicate a flow condition, such as uplink or downlink. The assistance information may indicate link conditions, such as direct path and indirect path link conditions, sidelink conditions, delay, and/or bandwidth. The assistance information may indicate a suggested split, such as a suggested load balancing traffic descriptor. For example, the control plane signaling may include an assistance message that includes a recommendation on a split on downlink traffic and/or in an uplink, which may be used to determine policy and charging control (PCC) rules in the case of an ATSSS type of aggregation at a UPF. The application server 810, after receiving the control signaling, may respond with an acknowledgement (e.g., acknowledge recommendation split) to the anchor UE 802.

In some aspects, the anchor UE 802 and the relay UE 804 may exchange information to support a traffic split. The exchange of information may occur over a link between the anchor UE 802 and the relay UE 804. In some aspects, prior to the modem of the anchor UE 802 providing a suggested load balancing split or steering, the application client 808 may indicate SDFs for which the anchor UE 802 may provide assistance information.

In some aspects, the modem of the anchor UE 802 may provide signaling, to the application client 808, that indicates a mapping of multimodal flows to the two connections. For example, the signaling may include a suggestion that a first QoS flow go over a first link and a second QoS flow go over a second link. As another example, the signaling may indicate a split factor for a same SDF. The signaling may include a suggestion that 20% of a load go onto a first connection and a remaining 80% go onto a second connection. In an uplink direction, a signaling indication may terminate in the application client 808 of the anchor UE 802. In a downlink direction, the application client 808 may forward a signaling indication (e.g., a suggested split) to the application server 810. In some aspects, the modem of the anchor UE 802 may be configured with triggering conditions to provide cross-layer API signaling. For example, only when certain link conditions change, the modem of the anchor UE 802 may provide a new traffic split descriptor. The triggering conditions may include both anchor UE and relay UE link triggered conditions.

In some aspects, an application function (AF) may explicitly affect policy and control function (PCF) generation of PCC rules based at least in part on signaling from the modem of the anchor UE 802, where the signaling may indicate a suggested split or other information. The AF may provide a traffic descriptor and preferred access, which may be used to determine an ATSSS rule or any relevant traffic aggregation or split feature in the UPF 812.

As indicated above, FIG. 8 is provided as an example. Other examples may differ from what is described with regard to FIG. 8.

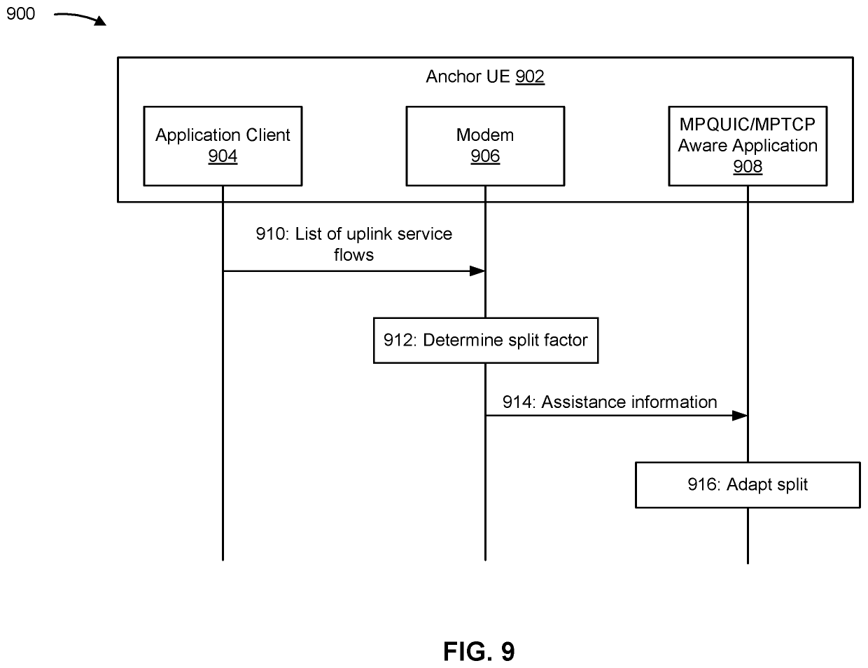

FIG. 9 is a diagram illustrating an example 900 associated with modem recommendations for traffic splitting, in accordance with the present disclosure. The example 900 includes an anchor UE 902. The anchor UE 902 may include an application client 904, a modem 906, and an MPQUIC/MPTCP aware application 908.

As shown by reference number 910, the application client 904 may provide, to the modem 906, a list of uplink service flows that are capable of undergoing a modem-assisted splitting or steering. As shown by reference number 912, the modem 906 may determine a split factor for uplink signals. For example, the modem 906 may determine that 80% of a multimodal QoS flow should be associated with a first link and the remaining 20% of the multimodal QoS flow should be associated with a second link. As another example, the modem 906 may determine that a first multimodal QoS flow should be associated with a first link and a second multimodal QoS flow should be associated with a second link. As shown by reference number 914, the modem 906 may send assistance information to the MPQUIC/MPTCP aware application 908, where the assistance information may indicate the split factor. The modem 906 may send the assistance information via a cross-layer API. In other words, in an uplink, the modem 906 may suggest a load balancing splitting or steering for at least one or more SDFs through the cross-layer API. As shown by reference number 916, the MPQUIC/MPTCP aware application 908 may adopt the suggested modem split factor, as indicated in the assistance information. For example, the MPQUIC/MPTCP aware application 908 may adapt the split of packets across two connections based at least in part on a modem suggested load balancing. Additionally, or alternatively, the MPQUIC/MPTCP aware application 908 may provide feedback to the modem 906, where the feedback may be in response to the suggested modem split factor indicated in the assistance information.

As indicated above, FIG. 9 is provided as an example. Other examples may differ from what is described with regard to FIG. 9.

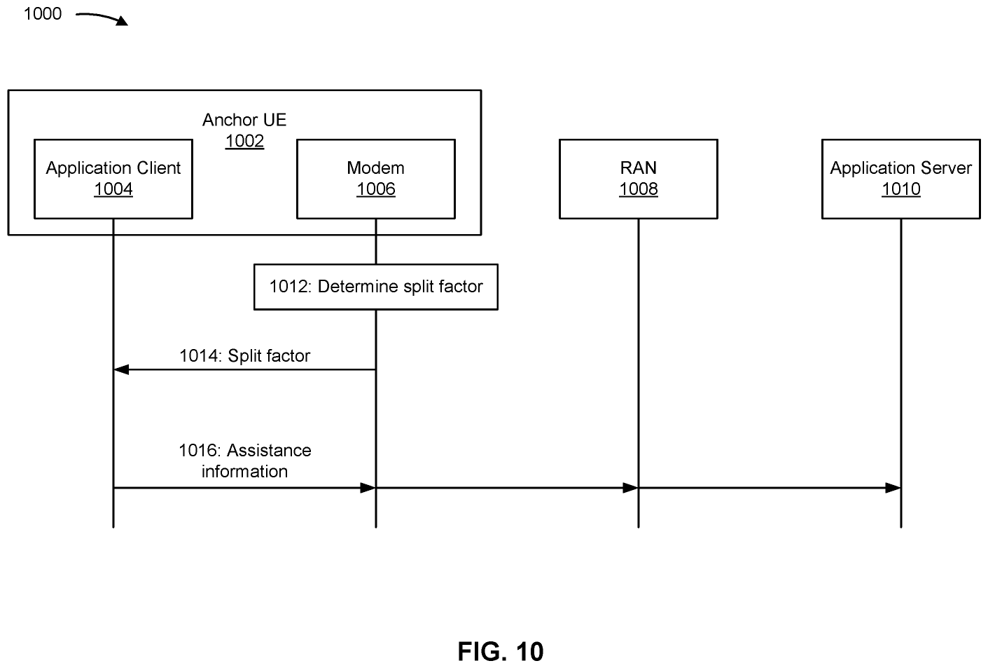

FIG. 10 is a diagram illustrating an example 1000 associated with modem recommendations for traffic splitting, in accordance with the present disclosure. The example 1000 includes an anchor UE 1002, RAN 1008, and an application server 1010. The anchor UE 1002 may include an application client 1004 and a modem 1006.

As shown by reference number 1012, the modem 1006 may determine a split factor among two connections. The split factor may be associated with a downlink direction. As shown by reference number 1014, the modem 1006 may send assistance information to the application client 1004, where the assistance information may indicate a suggested split factor. The modem 1006 may send the assistance information via a cross-layer API. As shown by reference number 1016, the application client 1004 may send the assistance information to the application server 1010 via the RAN 1008. In other words, the application client 1004 may forward the assistance information (e.g., suggested split factor) to the application server 1010, where the application server 1010 may or may not implement the suggested split factor in the downlink direction.

As indicated above, FIG. 10 is provided as an example. Other examples may differ from what is described with regard to FIG. 10.

FIG. 11 is a diagram illustrating an example process 1100 performed, for example, at a first UE or an apparatus of a first UE, in accordance with the present disclosure. Example process 1100 is an example where the apparatus or the UE (e.g., UE 120) performs operations associated with modem recommendations for traffic splitting.

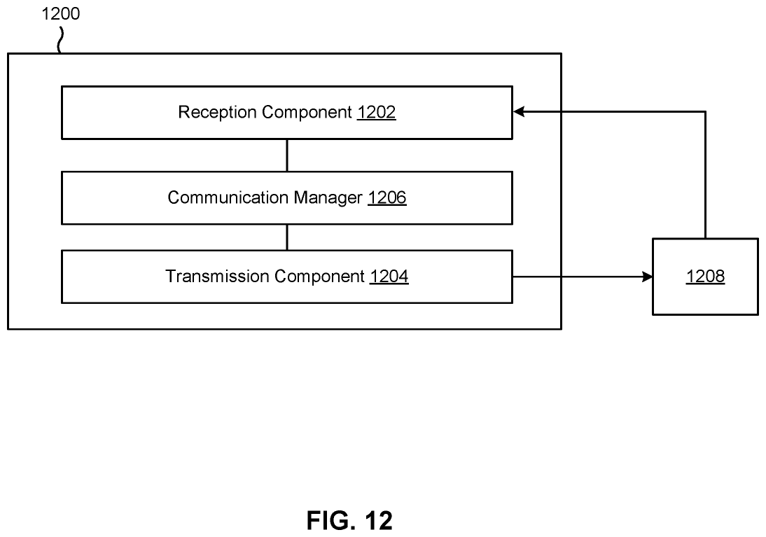

As shown in FIG. 11, in some aspects, process 1100 may include identifying, by a modem of the UE, a recommended traffic split between a first connection associated with the first UE and a second connection associated with a second UE (block 1110). For example, the first UE (e.g., using communication manager 1206, depicted in FIG. 12) may identify, by a modem of the UE, a recommended traffic split between a first connection associated with the first UE and a second connection associated with a second UE, as described above, e.g., at 912 of FIG. 9 and at 1012 of FIG. 10.

As further shown in FIG. 11, in some aspects, process 1100 may include providing, by the modem, assistance information indicating the recommended traffic split using a cross-layer API (block 1120). For example, the first UE (e.g., using communication manager 1206, depicted in FIG. 12) may provide, by the modem, assistance information indicating the recommended traffic split using a cross-layer API, as described above, e.g., at 914 of FIG. 9 and at 1016 of FIG. 10.

Process 1100 may include additional aspects, such as any single aspect or any combination of aspects described below and/or in connection with one or more other processes described elsewhere herein.

In a first aspect, the assistance information is provided to an application client of the first UE, and process 1100 includes forwarding, via the application client, the assistance information to an application server, wherein the cross-layer API is to the application client.

In a second aspect, alone or in combination with the first aspect, forwarding the assistance information to the application server is based at least in part on in-band signaling or control plane signaling.

In a third aspect, alone or in combination with one or more of the first and second aspects, the assistance information includes information on a first link condition associated with the first connection and a second link condition associated with the second connection, and the information indicates one or more of a throughput, a bandwidth, a delay, or a sidelink condition for each connection.

In a fourth aspect, alone or in combination with one or more of the first through third aspects, the assistance information includes a flow direction associated with the recommended traffic split, and the flow direction is an uplink flow direction or a downlink flow direction.

In a fifth aspect, alone or in combination with one or more of the first through fourth aspects, the recommended traffic split is for a downlink adaptive load balancing via an application server.

In a sixth aspect, alone or in combination with one or more of the first through fifth aspects, the recommended traffic split is for an uplink adaptive load balancing via the first UE.

In a seventh aspect, alone or in combination with one or more of the first through sixth aspects, a splitting of uplink packets of a service data flow occurs above an IP layer of the first UE using an MPQUIC or MPTCP aware application of the first UE.

In an eighth aspect, alone or in combination with one or more of the first through seventh aspects, the cross-layer API is a dedicated API to the MPQUIC or MPTCP aware application.

In a ninth aspect, alone or in combination with one or more of the first through eighth aspects, process 1100 includes adopting, by the MPQUIC or MPTCP aware application, the recommended traffic split, wherein the recommended traffic split is an uplink traffic split, or providing, to the modem, feedback indicating that the recommended traffic split is not adopted.

In a tenth aspect, alone or in combination with one or more of the first through ninth aspects, process 1100 includes controlling, via the modem, a load balancing or splitting of packets based at least in part on the assistance information when an aggregation or splitting of packets is above an IP layer of an application server or of the first UE, respectively.

In an eleventh aspect, alone or in combination with one or more of the first through tenth aspects, the recommended traffic split is to satisfy a multimodal synchronization requirement for two QoS flows, wherein the two QoS flows are associated with two or more of a visual QoS flow, an audio QoS flow, or a tactile QoS flow.

In a twelfth aspect, alone or in combination with one or more of the first through eleventh aspects, process 1100 includes receiving, from the second UE, information to support a traffic split between the first connection and the second connection.

In a thirteenth aspect, alone or in combination with one or more of the first through twelfth aspects, process 1100 includes receiving, by the modem from an application client of the first UE, an indication of possible service data flows for which the modem is able to provide assistance information.

In a fourteenth aspect, alone or in combination with one or more of the first through thirteenth aspects, the assistance information includes a mapping of multimodal flows to the first connection and the second connection.

In a fifteenth aspect, alone or in combination with one or more of the first through fourteenth aspects, the mapping indicates that a first traffic percentage of a multimodal QoS flow is to be associated with the first connection and a second traffic percentage of the multimodal QoS flow is to be associated with the second connection, or a first multimodal QoS flow is to be associated with the first connection and a second multimodal QoS flow is to be associated with the second connection.

In a sixteenth aspect, alone or in combination with one or more of the first through fifteenth aspects, the assistance information is provided based at least in part on a triggering condition being satisfied.

In a seventeenth aspect, alone or in combination with one or more of the first through sixteenth aspects, a PCF generation of PCC rules is based at least in part on modem-initiated signaling from the modem.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first UE, or a first UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8-10. Additionally, or alternatively, the apparatus 1200 may be configured to perform one or more processes described herein, such as process 1100 of FIG. 11, or a combination thereof. In some aspects, the apparatus 1200 and/or one or more components shown in FIG. 12 may include one or more components of the first UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the first UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the first UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may identify, by a modem of the first UE, a recommended traffic split between a first connection associated with the first UE and a second connection associated with a second UE. The communication manager 1206 may provide, by the modem, assistance information indicating the recommended traffic split using a cross-layer API.

The transmission component 1204 may forward, via an application client of the first UE, the assistance information to an application server, wherein the cross-layer API is to the application client. The communication manager 1206 may adopt, by the MPQUIC or MPTCP aware application, the recommended traffic split, wherein the recommended traffic split is an uplink traffic split. The communication manager 1206 may provide, to the modem, feedback indicating that the recommended traffic split is not adopted. The communication manager 1206 may control, via the modem, a load balancing or splitting of packets based at least in part on the assistance information when an aggregation or splitting of packets is above an IP layer of an application server or of the first UE, respectively. The reception component 1202 may receive, from the second UE, information to support a traffic split between the first connection and the second connection. The communication manager 1206 may receive, by the modem from an application client of the first UE, an indication of possible service data flows for which the modem is able to provide assistance information

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a first user equipment (UE), comprising: identifying, by a modem of the first UE, a recommended traffic split between a first connection associated with the first UE and a second connection associated with a second UE; and providing, by the modem, assistance information indicating the recommended traffic split using a cross-layer application programming interface (API).
Aspect 2: The method of Aspect 1, wherein the assistance information is provided to an application client of the first UE, and further comprising: forwarding, via the application client, the assistance information to an application server, wherein the cross-layer API is to the application client.
Aspect 3: The method of Aspect 2, wherein forwarding the assistance information to the application server is based at least in part on in-band signaling or control plane signaling.
Aspect 4: The method of any of Aspects 1-3, wherein the assistance information includes information on a first link condition associated with the first connection and a second link condition associated with the second connection, and the information indicates one or more of a throughput, a bandwidth, a delay, or a sidelink condition for each connection.
Aspect 5: The method of any of Aspects 1-4, wherein the assistance information includes a flow direction associated with the recommended traffic split, and the flow direction is an uplink flow direction or a downlink flow direction.
Aspect 6: The method of any of Aspects 1-5, wherein the recommended traffic split is for a downlink adaptive load balancing via an application server.
Aspect 7: The method of any of Aspects 1-6, wherein the recommended traffic split is for an uplink adaptive load balancing via the first UE.
Aspect 8: The method of any of Aspects 1-7, wherein a splitting of uplink packets of a service data flow occurs above an Internet Protocol (IP) layer of the first UE using a multipath quick user datagram protocol Internet connection (MPQUIC) or multipath transmission control protocol (MPTCP) aware application of the first UE.
Aspect 9: The method of Aspect 8, wherein the cross-layer API is a dedicated API to the MPQUIC or MPTCP aware application.
Aspect 10: The method of Aspect 9, further comprising: adopting, by the MPQUIC or MPTCP aware application, the recommended traffic split, wherein the recommended traffic split is an uplink traffic split; or providing, to the modem, feedback indicating that the recommended traffic split is not adopted.
Aspect 11: The method of any of Aspects 1-10, further comprising: controlling, via the modem, a load balancing or splitting of packets based at least in part on the assistance information when an aggregation or splitting of packets is above an Internet Protocol (IP) layer of an application server or of the first UE, respectively.
Aspect 12: The method of any of Aspects 1-11, wherein the recommended traffic split is to satisfy a multimodal synchronization requirement for two quality of service (QOS) flows, wherein the two QoS flows are associated with two or more of: a visual QoS flow, an audio QoS flow, or a tactile QoS flow.
Aspect 13: The method of any of Aspects 1-12, further comprising: receiving, from the second UE, information to support a traffic split between the first connection and the second connection.
Aspect 14: The method of any of Aspects 1-13, further comprising: receiving, by the modem from an application client of the first UE, an indication of possible service data flows for which the modem is able to provide assistance information.
Aspect 15: The method of any of Aspects 1-14, wherein the assistance information includes a mapping of multimodal flows to the first connection and the second connection.
Aspect 16: The method of Aspect 15, wherein the mapping indicates that: a first traffic percentage of a multimodal quality of service (QOS) flow is to be associated with the first connection and a second traffic percentage of the multimodal QoS flow is to be associated with the second connection, or a first multimodal QoS flow is to be associated with the first connection and a second multimodal QoS flow is to be associated with the second connection.
Aspect 17: The method of any of Aspects 1-16, wherein the assistance information is provided based at least in part on a triggering condition being satisfied.
Aspect 18: The method of any of Aspects 1-17, wherein a policy and control function (PCF) generation of policy and charging control (PCC) rules is based at least in part on modem-initiated signaling from the modem.
Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.
Aspect 20: An apparatus for wireless communication at a device, the apparatus comprising one or more memories and one or more processors coupled to the one or more memories, the one or more processors configured to cause the device to perform the method of one or more of Aspects 1-18.
Aspect 21: An apparatus for wireless communication, the apparatus comprising at least one means for performing the method of one or more of Aspects 1-18.
Aspect 22: A non-transitory computer-readable medium storing code for wireless communication, the code comprising instructions executable by one or more processors to perform the method of one or more of Aspects 1-18.
Aspect 23: A non-transitory computer-readable medium storing a set of instructions for wireless communication, the set of instructions comprising one or more instructions that, when executed by one or more processors of a device, cause the device to perform the method of one or more of Aspects 1-18.
Aspect 24: A device for wireless communication, the device comprising a processing system that includes one or more processors and one or more memories coupled with the one or more processors, the processing system configured to cause the device to perform the method of one or more of Aspects 1-18.
Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first user equipment (UE), comprising:
one or more memories; and
one or more processors coupled to the one or more memories, the one or more processors individually or collectively configured to:
identify, by a modem of the first UE, a recommended traffic split between a first connection associated with the first UE and a second connection associated with a second UE; and
provide, by the modem, assistance information indicating the recommended traffic split using a cross-layer application programming interface (API).

2. The apparatus of claim 1, wherein the assistance information is provided to an application client of the first UE, and the one or more processors are individually or collectively configured to:
forward, via the application client, the assistance information to an application server, wherein the cross-layer API is to the application client.

3. The apparatus of claim 2, wherein the one or more processors are individually or collectively configured to forward the assistance information to the application server based at least in part on in-band signaling or control plane signaling.

4. The apparatus of claim 1, wherein the assistance information includes information on a first link condition associated with the first connection and a second link condition associated with the second connection, and the information indicates one or more of a throughput, a bandwidth, a delay, or a sidelink condition for each connection.

5. The apparatus of claim 1, wherein the assistance information includes a flow direction associated with the recommended traffic split, and the flow direction is an uplink flow direction or a downlink flow direction.

6. The apparatus of claim 1, wherein the recommended traffic split is for a downlink adaptive load balancing via an application server.

7. The apparatus of claim 1, wherein the recommended traffic split is for an uplink adaptive load balancing via the first UE.

8. The apparatus of claim 1, wherein a splitting of uplink packets of a service data flow occurs above an Internet Protocol (IP) layer of the first UE using a multipath quick user datagram protocol Internet connection (MPQUIC) or multipath transmission control protocol (MPTCP) aware application of the first UE.

9. The apparatus of claim 8, wherein the cross-layer API is a dedicated API to the MPQUIC or MPTCP aware application.

10. The apparatus of claim 9, wherein the one or more processors are individually or collectively configured to:
adopt, by the MPQUIC or MPTCP aware application, the recommended traffic split, wherein the recommended traffic split is an uplink traffic split; or
provide, to the modem, feedback indicating that the recommended traffic split is not adopted.

11. The apparatus of claim 1, wherein the one or more processors are individually or collectively configured to:
control, via the modem, a load balancing or splitting of packets based at least in part on the assistance information when an aggregation or splitting of packets is above an Internet Protocol (IP) layer of an application server or of the first UE, respectively.

12. The apparatus of claim 1, wherein the recommended traffic split is to satisfy a multimodal synchronization requirement for two quality of service (QOS) flows, wherein the two QoS flows are associated with two or more of: a visual QoS flow, an audio QoS flow, or a tactile QoS flow.

13. The apparatus of claim 1, wherein the one or more processors are individually or collectively configured to:
receive, from the second UE, information to support a traffic split between the first connection and the second connection.

14. The apparatus of claim 1, wherein the one or more processors are individually or collectively configured to:
receive, by the modem from an application client of the first UE, an indication of possible service data flows for which the modem is able to provide assistance information.

15. The apparatus of claim 1, wherein the assistance information includes a mapping of multimodal flows to the first connection and the second connection.

16. The apparatus of claim 15, wherein the mapping indicates that:
a first traffic percentage of a multimodal quality of service (QOS) flow is to be associated with the first connection and a second traffic percentage of the multimodal QoS flow is to be associated with the second connection, or
a first multimodal QoS flow is to be associated with the first connection and a second multimodal QoS flow is to be associated with the second connection.

17. The apparatus of claim 1, wherein the assistance information is provided based at least in part on a triggering condition being satisfied.

18. The apparatus of claim 1, wherein a policy and control function (PCF) generation of policy and charging control (PCC) rules is based at least in part on modem-initiated signaling from the modem.

19. A method of wireless communication performed by a first user equipment (UE), comprising:
identifying, by a modem of the first UE, a recommended traffic split between a first connection associated with the first UE and a second connection associated with a second UE; and
providing, by the modem, assistance information indicating the recommended traffic split using a cross-layer application programming interface (API).

20. A non-transitory computer-readable medium storing a set of instructions for wireless communication, the set of instructions comprising:
one or more instructions that, when executed by one or more processors of a first user equipment (UE), cause the first UE to:
identify, by a modem of the first UE, a recommended traffic split between a first connection associated with the first UE and a second connection associated with a second UE; and
provide, by the modem, assistance information indicating the recommended traffic split using a cross-layer application programming interface (API).
